(19) United States
(12) Patent Application Publication
(10) Pub. No.: US 2007/0069477 A1
(43) Pub. Date: Mar. 29, 2007

(54) Stepped labyrinth damper seal

(75) Inventors: Jiming Li, Monroeville, PA (US); Pranabesh De Choudhury, Greensburg, PA (US)

Correspondence Address: THE WEBB LAW FIRM, P.C., 700 KOPPERS BUILDING, 436 SEVENTH AVENUE, PITTSBURGH, PA, 15219, US

(73) Assignee: Elliott Company, Jeannette, PA (US)

(21) Appl. No.: 10/560,798

(22) PCT Filed: Jun. 18, 2004
(86) PCT No.: PCT/US04/19495

§ 371 Date: Nov. 14, 2006

Related U.S. Application Data
(60) Provisional application No. 60/480,146, filed on Jun. 20, 2003.

(51) Int. Cl. F16J 15/447

(52) U.S. Cl. 277/415

(57) ABSTRACT

An apparatus for restricting axial leakage flow through the clearance between a rotating shaft and a seal stator comprises a stepped shaft surface and seal stator having a plurality of damper sections and being interleaved and adjacent.

### BACKGROUND OF THE INVENTION

Centrifugal compressors are rotating machines. They are comprised of stationary portions referred to as stators and rotating portions known as rotors. The rotors are supported on journal bearings in the stator. Differential gas pressure in the axial direction along the shaft tends to cause leakage flow along the shaft from higher to lower pressure regions. This leakage flow is detrimental for various reasons. Hence, seals are positioned along the shaft to restrict this leakage flow. In centrifugal compressors, use of labyrinth seals and especially stepped labyrinth seals are well known. Stepped labyrinth seals provide a tortuous path along the shaft minimizing leakage flow. Generally, stepped labyrinth seals comprise a plurality of radial teeth extending from the stator with a small radial clearance at the tips of the teeth as shown in FIG. 5. One of the detriments of leakage flow through stepped labyrinth seals is that it can be the cause of rotor instability.

Another type of seal is known as a damper seal. Damper seals have the ability to exert damping forces on the shaft that attenuate the vibration of the shaft. There are a number of types of damper seals. By in large, damper seals have a larger clearance than labyrinth seals and, therefore, are not as effective at preventing axial leakage flow.

It is an object according to this invention to provide a combination of damper seals and labyrinth seals associated in a way that they do not interfere with each other's function.

### SUMMARY OF THE INVENTION

Briefly, according to this invention, there is provided an apparatus for restricting axial flow through the clearance between a rotating shaft and a seal stator and providing necessary damping to improve rotor stability. The shaft has a stepped surface with a plurality of sections of a first diameter and a plurality of grooved sections of a second lesser diameter. The sections of first and second diameter are interleaved and adjacent. The seal stator has a plurality of damper seal segments opposite the shaft sections of the first diameter and a plurality of labyrinth seal segments opposite the shaft sections of second diameter. The labyrinth seal segment comprises one or more annular teeth that extend from the stator toward the shaft terminating with a very small clearance.

### BRIEF DESCRIPTION OF THE DRAWINGS

Further features and other objects and advantages will become clear from the following detailed description made with reference to the drawings in which:

FIG. 1 is a section view through a stepped labyrinth damper seal according to this invention;

FIG. 2 is a drawing of a non-abradable slotted pocket damper seal on stator;

FIG. 3 is an unwrapped view of a non-abradable honeycomb damper seal on stator;

FIG. 4 is an unwrapped view of a non-abradable hole-pattern damper seal on stator; and

FIG. 5 is a section view of a prior art stepped labyrinth seal.

### DESCRIPTION OF THE PREFERRED EMBODIMENTS

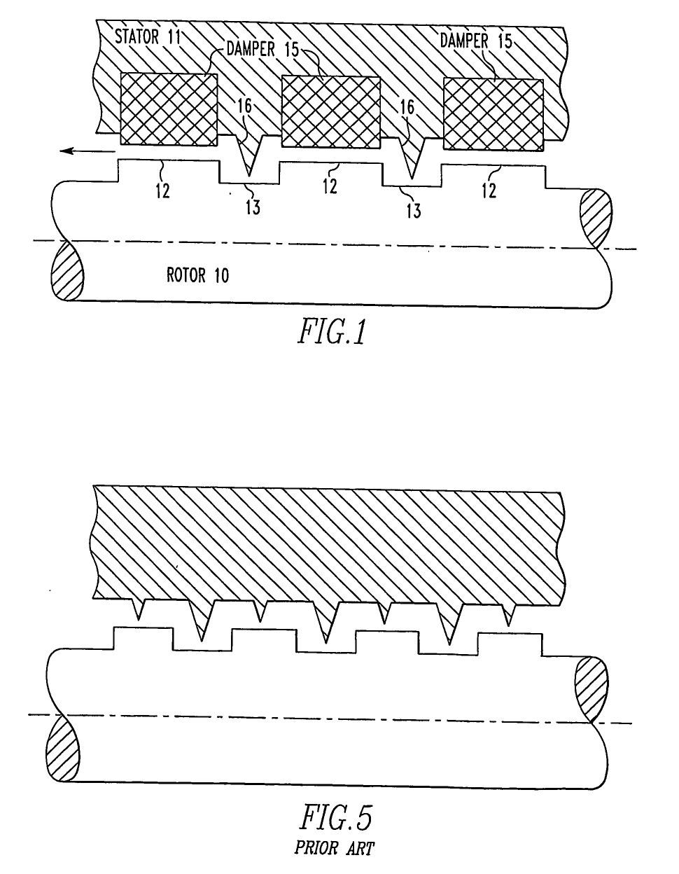

Referring to FIG. 1, there is shown a stepped labyrinth damper seal according to this invention for restricting axial flow and providing necessary damping. It comprises a rotor portion 10 and a stator portion 11. The rotor portion has a shaft with a stepped surface with a plurality of land sections 12 of a first diameter and a plurality of grooved sections 13 of a second lesser diameter. Damper segments 15 are arranged in the stator radially outward of the land sections 12. A labyrinth seal tooth 16 is arranged within each of the grooved sections 13. Teeth extending into the grooves form a tortuous path to effectively reduce the seal leakage.

Referring to FIG. 2, there is shown a non-abradable slotted pocket damper with teeth on the stator. The tip of the teeth of the pocket damper ride over the land sections 12 as seen in FIG. 1. Partition walls divide the annular grooves into several individual pockets and reduce the circumferential flow velocity in the seal. Tests have confirmed that the slotted pocket damper provides more effective damping than conventional labyrinth seals.

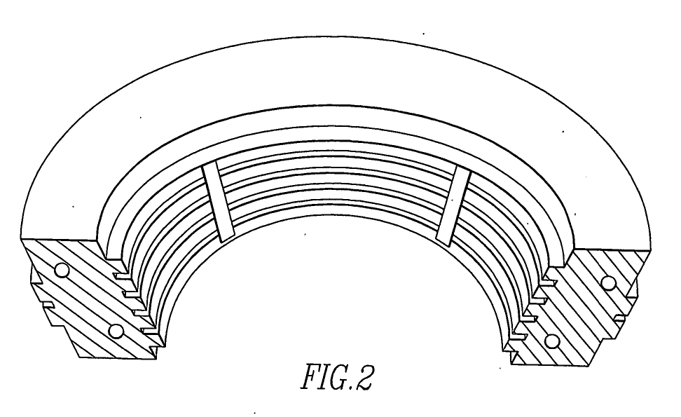

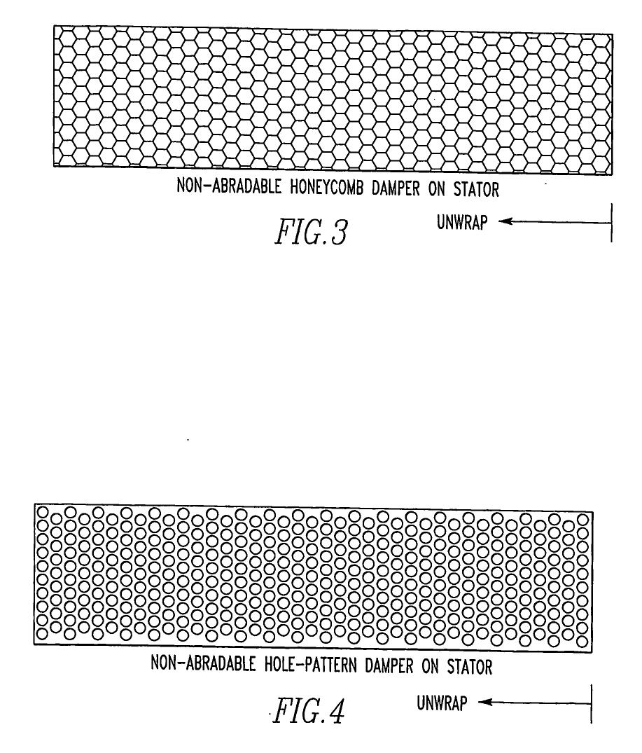

Referring to FIG. 3, there is shown a non-abradable honeycomb damper segment. The damper segment in use would be fixed to the stator 11 over the land sections 12 as seen in FIG. 1. Referring to FIG. 4, there is shown a non-abradable hole-pattern damper segment that may replace the honeycomb segment. Tests indicate that the honeycomb and hole-pattern dampers are superior to labyrinth seals in damping performance. The geometry of the pocket damper, honeycomb damper or hole pattern damper can be optimized based on the seal operating conditions.

Having thus described our invention with the detail and particularity required by the Patent Laws, what is desired protected by Letters Patent is set forth in the following claims.

The invention claimed is:

1. An apparatus for restricting axial leakage flow through the clearance between a rotating shaft and a seal stator and providing necessary damping to improve rotor stability comprising:
said shaft having a stepped surface, said surface having a plurality of sections of a first diameter and a plurality of sections of a second lesser diameter being interleaved and adjacent;
said seal stator having a plurality of damper sections and a plurality of labyrinth sections, said sections of damping and labyrinth being interleaved and adjacent;
said damper sections of the seal stator adjacent the shaft section of first diameter to provide damping; and
said labyrinth sections of the seal stator adjacent the shaft of second diameter to form a tortuous flow path for reducing seal leakage.

2. The seal stator according to claim 1, wherein the damper sections are slotted pocket segments.

3. The seal stator according to claim 1, wherein the damper sections are honeycomb segments.

4. The seal stator according to claim 1, wherein the damper sections are hole pattern segments.
